(19) United States
(12) Patent Application Publication
(10) Pub. No.: US 2010/0297474 A1
(43) Pub. Date: Nov. 25, 2010

(54) Atomic Layer Deposition Process

(75) Inventor: Arrelaine A. Dameron, Boulder, CO (US)

Correspondence Address: ARNOLD & KNOBLOCH, L.L.P., 4900 Woodway Dr., Suite 900, HOUSTON, TX, 77056, US

(73) Assignee: HCF Partners, LP., Houston, TX (US)

(21) Appl. No.: 12/741,689

(22) PCT Filed: Oct. 30, 2008
(86) PCT No.: PCT/US08/81884

§ 371 Date: Aug. 10, 2010

Related U.S. Application Data
(60) Provisional application No. 60/985,931, filed on Nov. 6, 2007.

(51) Int. Cl. B05D 5/12; B32B 9/00

(52) U.S. Cl. 428/702; 427/126.4; 427/126.1

(57) ABSTRACT

The invention provides methods for selectively coating a substrate surface comprising a first and a second material with a thin film of a protective material using an atomic layer deposition process.

### CROSS-REFERENCE TO RELATED APPLICATIONS

This application claims the priority benefit of U.S. Provisional Application No. 60/985,931, filed Nov. 6, 2007, which is incorporated herein by reference in its entirety.

### FIELD OF THE INVENTION

The invention relates to methods for selectively coating a substrate surface comprising a first and a second materials with a thin film of a protective material using an atomic layer deposition process.

### BACKGROUND OF THE INVENTION

Fabrication of semiconductors and other electronic devices often use a masking process to apply a coating of protective layer. Typical masking processes include, but are not limited to, chemical vapor deposition (CVD) and atomic layer deposition (ALD).

Atomic layer deposition (ALD) is a vapor phase process; therefore, the deposited materials typically coat samples everywhere without any discrimination. Furthermore, it is not possible to pattern ALD films because it is not a line of sight process. One solution is to use a mask, e.g., via photolithography, and then use an ALD process. Unfortunately, using the mask increases the time and cost to the electronic fabrication process. Furthermore, it is not always possible to use the mask. Moreover, photoresists and liftoff materials (generally polymeric materials), which are typically used in photolithography processes, adsorb the ALD chemical precursors and must be used selectively.

Accordingly, there is a need for a method for coating a portion of a substrate selectively using ALD without the need for using a mask.

### SUMMARY OF THE INVENTION

The invention provides methods for selectively coating a substrate surface with a thin film of a protective material using an ALD process.

Some aspects of the invention provide a method for surface coating a non-conductive region of a substrate comprising a conductive region and a non-conductive region on its surface, said method comprising forming a layer of thin film using an ALD process with a coating material under conditions sufficient to selectively form a thin film on the non-conductive region of the substrate surface.

In some embodiments, the thin film is an insulating film.

Yet in other embodiments, the thin film comprises aluminum oxide. Within these embodiments, in some instances the coating material comprises trimethylaluminum. Still in other instances, the surface of the conductive region comprises copper oxide. Within these instances, in some cases, the atomic layer deposition process is conducted in a substantially non-reducing condition.

Still in other embodiments, the non-conductive region comprises silicon dioxide.

Yet in other embodiments, methods of the invention further comprise repeating the atomic layer deposition process with a second coating material. Within these embodiments, in some instances the coating material and the second coating material are same. Still in other instances, the coating material and the second coating material are different.

Other aspects of the invention provide methods for selectively coating a substrate surface with a thin film of a protective material, wherein said substrate surface comprises a first and a second material. Such methods comprise forming a layer of thin film using an atomic layer deposition process with a coating material under conditions sufficient to selectively form a thin film of a protective material on the first material of the substrate surface.

In some embodiments, the first material is a non-conductive material.

In other embodiments, the second material is a conductive material.

Other aspects of the invention provide an electronic device comprising a substrate produced using the methods disclosed herein.

In some embodiments, the electronic device is a display element.

Yet in other embodiments, the electronic device comprises a display element.

Still in other embodiments, the electronic device is a photovoltaic element.

In other embodiments, the electronic device is a radio frequency identity element.

### BRIEF DESCRIPTION OF THE DRAWINGS

FIG. 1 is a photograph of samples before (right) and after (left) Al₂O₃ growth;

FIG. 2 is current versus voltage plots of the Cu regions before and after Al₂O₃ deposition;

FIG. 3 is a comparative graph showing the current efficiency of an ALD encapsulated OLED and a glass/epoxy encapsulated OLED device;

FIG. 4 is a comparative graph showing luminance versus voltage between an ALD encapsulated OLED and a glass/epoxy encapsulated OLED device; and

FIG. 5 is a comparative graph of current density versus voltage between an ALD encapsulated OLED device and a glass/epoxy encapsulated OLED device.

### DETAILED DESCRIPTION OF THE INVENTION

ALD is a self-limiting, sequential surface chemistry that deposits conformal thin-films of materials onto substrates of varying compositions. ALD film growth is self-limited and based on surface reactions, which makes achieving atomic scale deposition control possible. ALD is similar in chemistry to chemical vapor deposition (CVD), except that the ALD reaction breaks the CVD reaction into at least two separate reactions, keeping the precursor materials separate during the reaction. By keeping the precursors separate throughout the coating process, atomic layer control of film grown can be obtained by ALD.

ALD has advantages over other thin film deposition techniques, as ALD grown films are typically conformal, pin-hole free, and chemically bonded to the substrate. With ALD it is possible to deposit coatings uniform in thickness inside deep trenches, porous media and around particles. ALD can be used to deposit several types of thin films, including various ceramics, from conductors to insulators.

Unfortunately, because atomic layer deposition (ALD) is a vapor phase process, typically the deposited materials coat samples everywhere, that is, the film formation is indiscriminate in nature. Moreover, it is extremely difficult to pattern ALD films because ALD is not a line of sight process, for which a mask can be used.

The present invention provides methods for selectively coating a substrate surface with a thin film of a protective or insulating material using ALD. The substrate surface comprises at least two different materials, a first and a second material. Methods of the invention comprise forming a layer of thin film using ALD with a coating material under conditions sufficient to selectively form a thin film of a protective or insulating material on the first material of the substrate surface. As stated above, typically ALD coats the entire substrate surface. However, the present inventors have found that by selecting appropriate substrate surface materials and precursors ALD can be used to selectively coat different portion(s) of the substrate surface. Typically, methods of the invention coats the first material of the substrate surface selectively with a thin film and leaves the second material of the substrate surface substantially uncoated. It should be appreciated that while methods of the invention may coat some portions of the second material of the substrate surface, the overall process generally leaves the physical, chemical, and/or electrical property of the second material substantially unchanged. Typically, however, at least 90%, often at least 95%, and more often at least 98%, of the second material remains unchanged by methods of the invention.

Often the thin film is an insulating (e.g., electrically and/or thermally insulating) layer. Exemplary chemical compositions for the thin film that are suitable for methods of the invention include, but are not limited to, aluminum oxide, and silicon dioxide. The terms “electrically non-conducting” and “electrically insulating” are used interchangeably herein and refer to a material whose electrical resistance is at least about 5×10¹⁵ ohms cm⁻¹, often at least about 10¹⁷ ohms cm⁻¹, and more often at least about 10¹⁶ ohms cm⁻¹. The terms “thermally non-conducting” and “thermally insulating” are used interchangeably herein and refer to a material having thermoconductivity of about 20 W/m K or less, often about 18 W/m K or less, and more often about 22 W/m K or less.

The first material (can be either conductive or non-conductive) of the substrate surface is typically a non-conducting (e.g., electrically and/or thermally non-conducting) material. Exemplary first materials for the substrate surface include, but are not limited to, silicon oxide, aluminum, calcium, barium, silver or amalgams thereof and other non-electrically or non-thermally conducting non-metallic or polymeric materials.

In contrast to the first material, the second material of the substrate surface is typically conducting (e.g., electrically and/or thermally conducting) material. That is the physical material of the second material is generally selected to be contrary to that of the first material. Exemplary second materials for the substrate surface include metals and metal oxides (e.g., copper and copper oxide), and other electrically and/or thermally conducting metallic or polymeric materials.

Methods of the invention utilize selecting an appropriate thin film precursor material that will selectively coat the first material in the presence of the second material. In one particular embodiment, the thin film is comprised of aluminum oxide. Aluminum oxide can be deposited selectively on silicon oxide in the presence of copper oxide. Aluminum oxide layer can be formed by ALD using an aluminum trialkyl compound and water. In one specific embodiment, Al₂O₃ ALD surface chemistry is based on the sequential deposition of Al(CH₃)₃ and H₂O. The Al₂O₃ ALD surface chemistry is described by the following two sequential surface reactions:

AlOH.+Al(CH₃)₃→AlO—Al(CH_{c})₂.+CH₄ (1)

AlCH₃.+H₂O→AlOH.+CH₄ (2)

The surface chemistry, thin film grow rates, and thin film properties have been extensively studied for Al₂O₃ ALD. Each reaction cycle deposits about 1.2 Å of aluminum oxide layer per AB cycle.

Many inorganic films can be deposited with an ALD technique. SiO₂ and Al₂O₃ ALD films can also be deposited at low temperatures that are compatible with small molecule and polymeric materials or the plastic substrates used for example in the construction of flexible displays. Additionally, metallic materials can also be deposited by ALD methods. More recently organic and hybrid inorganic/organic materials have been demonstrated by a technique analogous to ALD using molecular layers to fabricate polymers called molecular layer deposition (MLD).

In some embodiments, copper (or copper oxide on the surface) is used to form a conductive pattern on a substrate, or to overcoat portions of an existing conductive pattern. Al₂O₃ atomic layer deposition (ALD) is used to fabricate insulating layers over the conductive pattern. The Al₂O₃ does not nucleate significantly on the Cu portions of the substrate, thus resulting in a patterned surface, with Al₂O₃ coating everywhere except where the Cu was deposited. This is an effective means of creating an ultrathin patterned surface of conductive and non-conductive/insulating regions of a substrate. Electrical connections can be made at these points without disturbing the ALD film.

Atomic layer deposition (ALD) is the process of fabricating thin films by sequential deposition of gas phase precursors. In some embodiments, Al₂O₃ films are usually deposited using trimethylaluminum and water. Al₂O₃ films can be grown onto most materials and has been demonstrated on a variety of substrates including metals, inorganic materials and polymeric materials. However, Al₂O₃ nucleation is limited on Cu surfaces. Cu surfaces with a native oxide block Al₂O₃ deposition in non-reductive conditions. Under reductive conditions (e.g., >300° C., with a reductive hydrogen stream) it is possible to nucleate Al₂O₃ films on Cu surfaces.

Al₂O₃ films have been used extensively as insulating materials and as diffusion barriers. ALD allows for the growth of ultrathin films, however patterning of the ALD films remains difficult. The present inventors have found that using Cu to pattern conductive regions, one can effectively pattern the ALD film to create conductive and non-conductive (insulating) regions on the same surface. Additionally one can overcoat conductive regions of a sample to protect those regions from ALD deposition but allow other regions to be insulated. Using this method one can create a matrix or pixel pattern of conductive and insulated regions. This is advantageous for device encapsulation/permeation barrier, device fabrication, and selective patterning applications.

Al₂O₃ can also be used to nucleate many other ALD films. Accordingly, methods of the invention can be used to pattern many other films.

Additional objects, advantages, and novel features of this invention will become apparent to those skilled in the art upon examination of the following examples thereof, which are not intended to be limiting.

### EXAMPLES

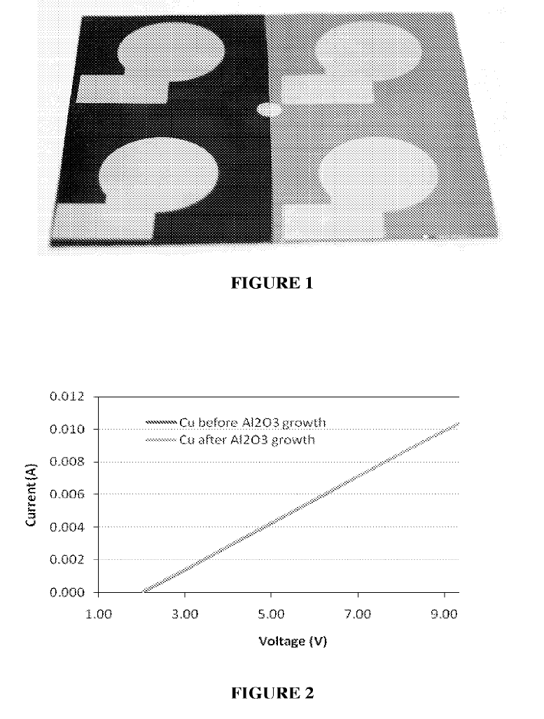

FIG. 1 is a photograph showing one particular demonstration of Al₂O₃ deposited on a SiO₂ surface with a Cu pattern using methods of the invention. In FIG. 1, one half of the sample was exposed to 830 cycles of Al₂O₃ ALD at 177° C. As can be seen, the deposition occurred selectively on the SiO₂ regions. FIG. 2 shows current versus voltage (IV) plots of the conductive pads before and after deposition. The IV plots are nearly identical. The insulating Al₂O₃ film is not present on the Cu regions.

ITO-coated glass was cleaned by sonication in a 2% Tergitol solution, followed by a rinsing in de-ionized water and immersion for 10 minutes in a 5:1:1 solution of DI water:ammonium hydroxide:hydrogen peroxide heated to 70° C. Substrates were then rinsed with DI water and sonicated in acetone and methanol for 15 minutes each. After drying with nitrogen, they were cleaned with UV/ozone. Copper was then deposited on the required contact points of the substrates using a shadow masked CVD process at a base pressure of 2×10⁻⁶ mbar at a rate of 2.5 nm s⁻¹ to a thickness of about 200 nm.

A multilayer OLED was fabricated utilizing CVD processes. The structure of this stack was indium tin oxide (ITO), N,N′-Bis(3-methylphenyl)-N,N′-bis(phenyl)-benzidine (TPD, 70.00 nm, re-sublimed, deposited at a rate of 5.0 Å s⁻¹), aluminum tris(8-hydroxyquinoline (Alq₃, 50.00 nm, re-sublimed, deposited at a rate of 5.0 Å s⁻¹), lithium fluoride (LiF, 1.50 nm, deposited at rate of 0.01 nm s⁻¹) and a cathode comprising Al deposited at a variable rate of between 5 and 25 nm s⁻¹. Film deposition was carried out at a base pressure of 2×10⁻⁶ mbar.

Half of the devices were then transferred to the ALD reactor under inert atmosphere and exposed to 200 cycles of Al₂O₃ ALD at 60° C. The remaining devices were encapsulated using a standard UV cure epoxy and glass slides.

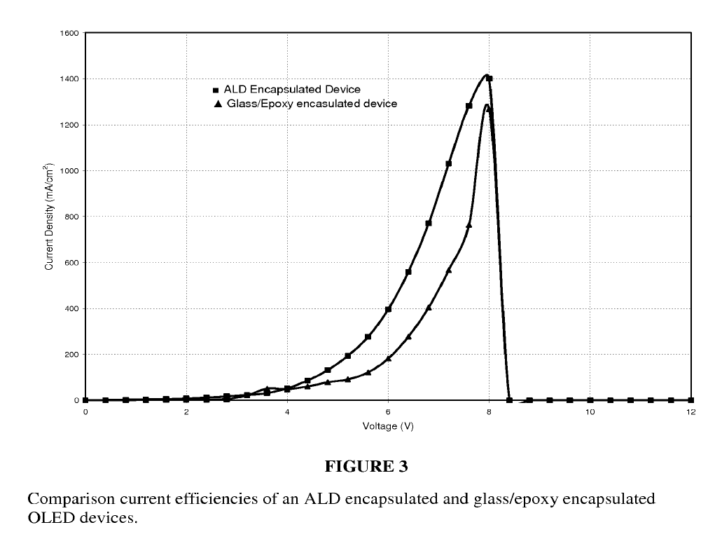

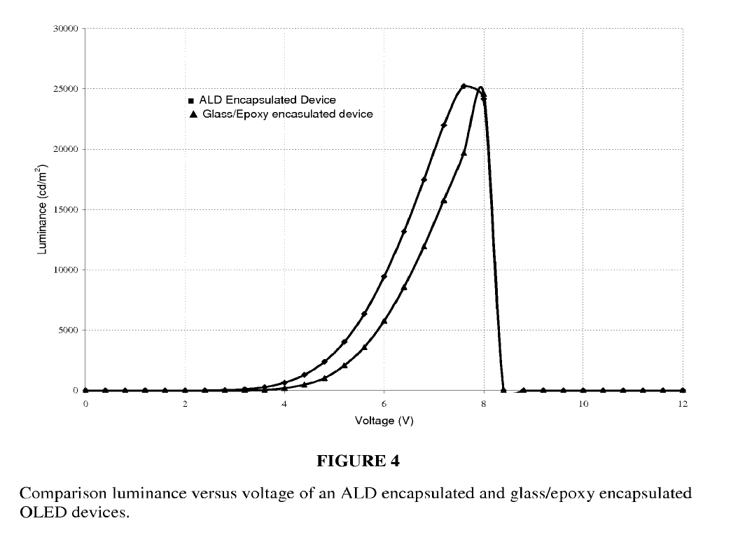

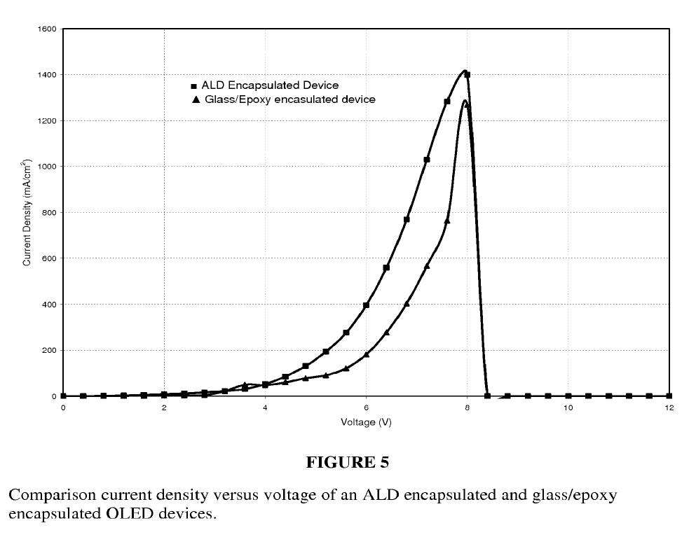

FIGS. 3 through 5 provide comparative electro-optic data for the respective devices. As can be seen, an ALD encapsulated OLED device had a significantly better electro-optic data.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed:

1. A method for surface coating a non-conductive region of a substrate comprising a conductive region and a non-conductive region on its surface, said method comprising forming a layer of thin film using an atomic layer deposition process with a coating material under conditions sufficient to selectively form a thin film on the non-conductive region of the substrate surface.

2. The method of claim 1, wherein the thin film is an insulating film.

3. The method of claim 1, wherein the thin film comprises aluminum oxide.

4. The method of claim 3, wherein the coating material comprises trimethylaluminum.

5. The method of claim 3, wherein the surface of the conductive region comprises copper oxide.

6. The method of claim 5, wherein the atomic layer deposition process is conducted in a substantially non-reducing condition.

7. The method of claim 1, wherein the non-conductive region comprises silicon dioxide.

8. The method of claim 1 further comprising repeating the atomic layer deposition process with a second coating material.

9. The method of claim 8, wherein the coating material and the second coating material are same.

10. The method of claim 8, wherein the coating material and the second coating material are different.

11. A method for selectively coating a substrate surface with a thin film of a protective material, wherein said substrate surface comprises a first and a second material, said method comprising forming a layer of thin film using an atomic layer deposition process with a coating material under conditions sufficient to selectively form a thin film of a protective material on the first material of the substrate surface.

12. The method of claim 11, wherein the first material is a non-conductive material.

13. The method of claim 11, wherein the second material is a conductive material.

14. An electronic device comprising a substrate produced using the method of claim 1.

15. The electronic device of claim 14, wherein said electronic device is a display element.

16. The electronic device of claim 14, wherein said electronic device is a photovoltaic element.

17. The electronic device of claim 14, wherein said electronic device is a radio frequency identity element.
